(19) United States
(12) Patent Application Publication
(10) Pub. No.: US 2016/0351178 A1
(43) Pub. Date: Dec. 1, 2016

(54) A DETACHABLE ELECTRODYNAMIC SOUND PICKUP AND AMPLIFICATION SYSTEM, WITH A REMOVABLE MOUNTING PLATE AND SELF-ADHESIVE CABLING

(71) Applicant: RIGAS MAKROPOULOS, LARISSA (GR)

(72) Inventor: RIGAS MAKROPOULOS, LARISSA (GR)

(21) Appl. No.: 15/039,434

(22) PCT Filed: Jan. 20, 2015
(86) PCT No.: PCT/GR2015/000005

§ 371 Date: May 26, 2016

(30) Foreign Application Priority Data
Jan. 29, 2014 (GR) 20140100049

(51) Int. Cl. G10H 3/18

(52) U.S. Cl. CPC G10H 3/183; G10H 3/181

(57) ABSTRACT

A detachable electrodynamic sound pickup and amplification system, with a removable mounting plate and self-adhesive cabling, for classical string instruments and other musical instruments having electrically conductive strings, whose operation is based on the voltage generated in the electrically conductive strings of the instrument when they move three-dimensionally within a suitably shaped magnetic field. The sliding, removable mounting plate (3) with magnets (2) is clamped to the end of the fingerboard (11) of the instrument by use of a clip (19), and electrical connections are possible through self-adhesive connectors so that after removal of the mounting plate (3) and the remaining parts of the system, the instrument remains intact, without the slightest indication of any kind of aesthetic or constructional alteration.

The described invention refers to a detachable electrodynamic sound pickup and amplification system for classical string instruments (violin, viola, cello, double-bass) and other musical instruments having electrically conductive strings. This system, is mounted on the instrument in such a way that no interventions or modifications of a constructional or aesthetic nature are made to the instrument itself, and when it is removed, the instrument remains intact, without the slightest indication of any kind of aesthetic or constructional alteration.

Up to the present, sound pickup of the above mentioned instruments has been either by use of a) microphones mounted on a stand, b) or coil magnets as on electro-acoustic guitars, c) or piezoelectric pickups (crystals) usually implanted in echogenic parts of the instruments or around them.

All three of the above mentioned solutions have serious drawbacks (e.g. audio microphone feedback, frequency filtering and colouring of the natural sound of the instrument, use of implants in different echogenic parts of the instrument, etc.), and frequently, their usage brings about modifications or alterations in the structure and construction of the instruments, adversely affecting their audio output, aesthetics and final appearance.

The present invention relates to a particular method of sound pickup and sound amplification for the above mentioned instruments, where the electrically conductive strings of instruments, inductively convert their sound into electrical signal by themselves. The audio signal comes out from the ends of the strings when they move three-dimensionally within a suitably shaped magnetic field.

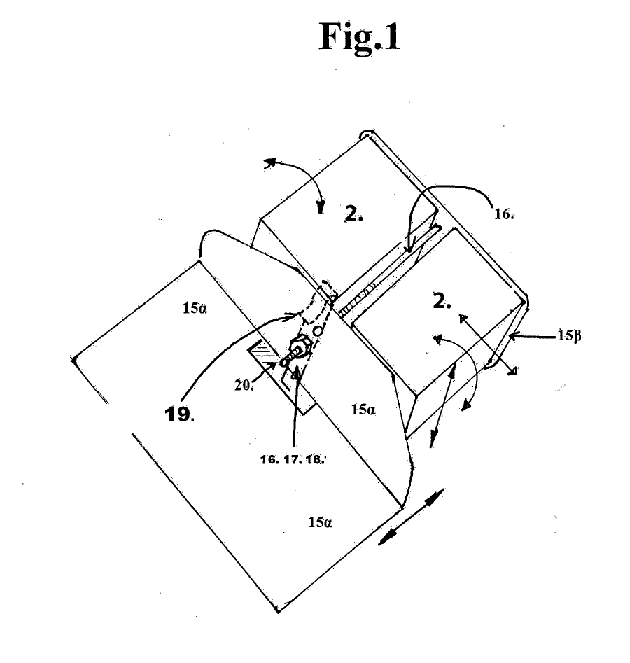

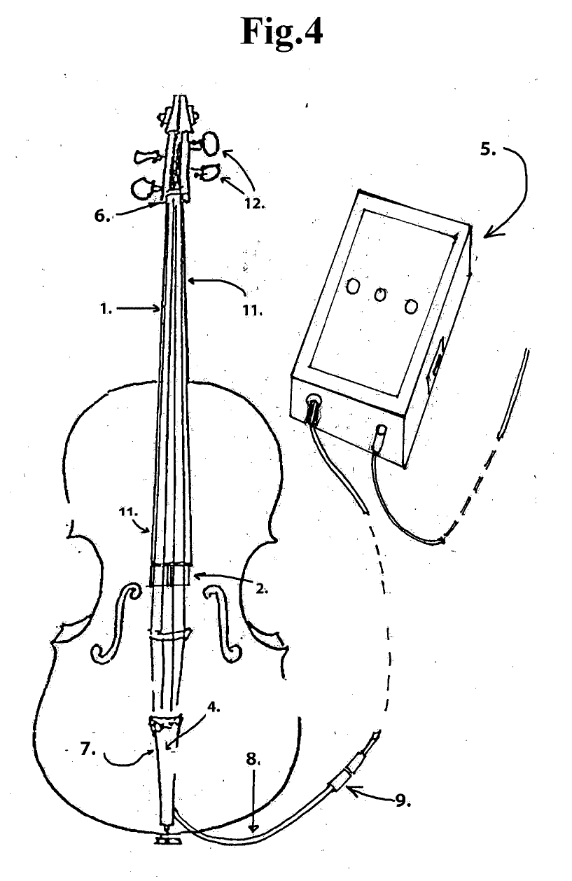

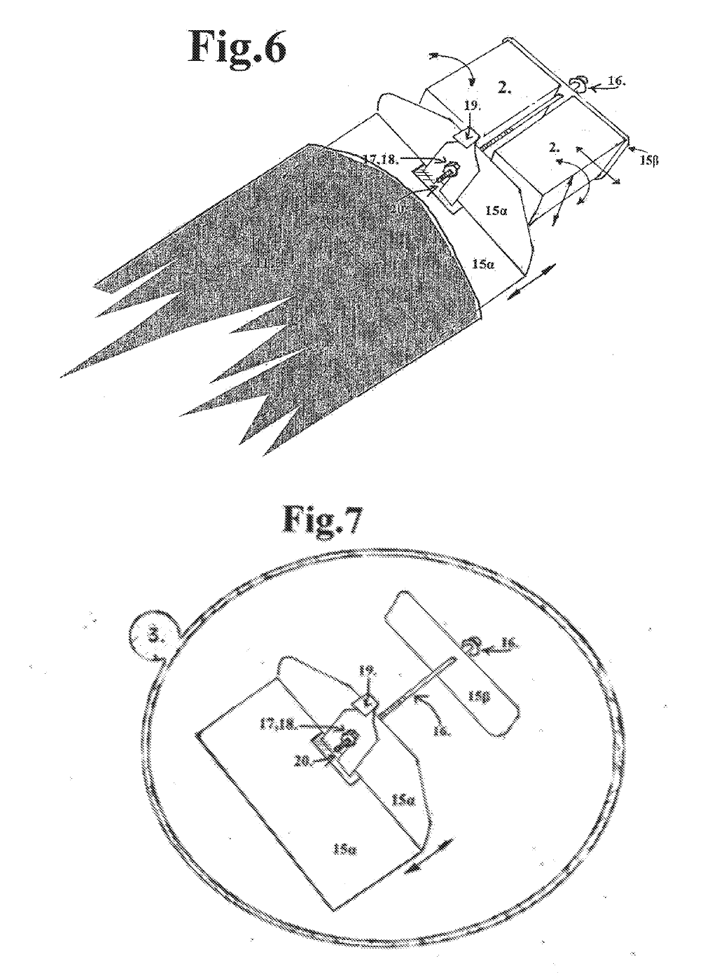

The complete system (FIG. 4) consists of a sliding removable mounting plate (3) (FIG. 7), on which two or more encapsulated permanent magnets are mounted (2) (FIG. 1), self-adhesive cabling (14), the electrically conductive strings of the instruments (1) as they are positioned and tuned therein, a non-electroconductive tailpiece (4), self-adhesive electrically conductive terminal(s) (6) in the pegbox (12), electrically conductive terminals (7) placed beneath the tailpiece, necessary cabling (8), a preamplifier (5) and an output connector (9).

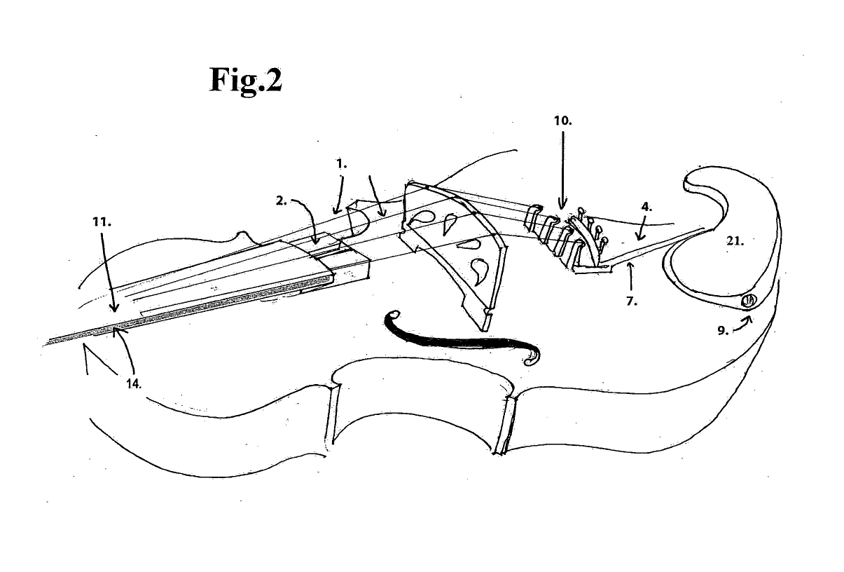

The sliding, easily removable mounting plate (3) with magnets (2) (FIG. 1) is clamped on the end of the fingerboard (11) of the instruments (FIGS. 2,6,8) by means of a hook/clip (19) so that no constructional or aesthetic interventions modifications to the instruments are required

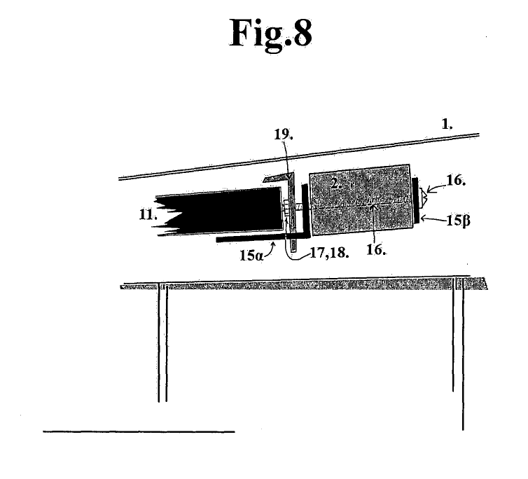

(FIG. 8). Consequently, after removal of the mounting plate (3) and the other parts of the system, the body remains intact, without the slightest indication of any kind of constructional alteration (e.g. punctures, replacements of certain parts, permanent solder or mounting of components, etc., which will inevitably affect adversely the sound produced) or aesthetic alteration (whatever alters the physical appearance of the instrument). The mounting point at the mounting plate (3) (at the end of the fingerboard/FIGS. 2,4,8) does not produce any sound, so its presence has absolutely no effect on the production of the natural sound and the timbre of the instrument.

The sliding, easily removable mounting plate (3)(FIG. 7), consists of two rigid surfaces (15a, 15b), a clip/hook (19) adjusted for height in accordance to the instrument, and at least one central attaching screw (16). The first surface (15a) is L-shaped and slidably mounted on the instrument by its longest side, beneath the fingerboard (11). Its shorter side lies adjacent to the end of the fingerboard (11), providing additional support (FIG. 8). At the end of the side inserted underneath the fingerboard (11) on the corner of this L-shaped surface (15a), there is a slot—aperture (20) (FIGS. 1,6,7) whose length permits the unimpeded vertical movement of the clip/hook (19) when it is adjusted for height as the mounting plate (3) is attached/clamped to the instrument. The rigid L-shaped surface (15a) is coated with non-slip and damping material for better stability, braking action and less creaking noises while playing the instrument. The second surface (15b) is a flat elongated plate coated with non-slip material, too, and attached to the first by a central screw (16) which penetrates both. The central screw (16) connecting the two rigid surfaces and the clip/hook (19) (FIG. 8) passes through the magnets and by this screw the rigid surfaces (15) in-between the permanent magnets (2) and the clip/hook (19) placed between the edge of the instrument fingerboard (11) and the rigid L-shaped surfaces (15a) are clamped/fastened by spring lock washers (17) and nuts (18) (FIGS. 1,6,7,8). The central screw (16) passes through the body of the hook/clip (19) and its end can hide under the instrument fingerboard during positioning thereto.

The mounting plate (3) is positioned at the end of the fingerboard (11) (FIGS. 2,4,6,8) and secured by the hook/clip (19), while in bigger instruments, such as the double-bass, it is usually supported by means of an adhesive patch, for extra stability.

The dimensions and shape of the mounting plate (3) may vary depending on the size of the instrument where it is attached to, and it can be easily detached from and re-attached to the instrument by the musician him-/herself.

The magnets (2), usually encapsulated, may have different sizes depending on the instrument which they are attached to, they are placed one alongside the other (FIG. 1), covalently or noncovalently, between the plates (15a and 15b) of the main mounting plate (3), and secured at a distance of a couple of millimetrers from the strings (1) of the instrument (FIGS. 2 & 8), creating the magnetic field necessary for the system to operate.

The way the magnets (2) are clamped to the mounting plate (3) (FIG. 1) allows their easy and safe placement, and gives them the possibility to move three-dimensionally and be at a three-dimensional distance from each string (1) (FIG. 1), contributing in this way to the adjustment of the volume and timbre of the signal generated by them. For example, the closer the proximity the magnets have to the strings, the greater the intensity of the produced signal from them.

Additionally, the possibility of a parallel arrangement—reversing the polarity of the magnets (2), in combination with proper connection of the strings (1), creates the conditions for controlling the phase of the induced electrical signal, this resulting in the system's ability to present humbucking (cancelling out the noise from the environment and external interference due to the difference in phases during amplification).

The number of the magnets used (2), typically two, can vary from one for use in all of the strings (1), one per pair of strings (1) to more magnets, e.g. one for each string (1), depending on the instrument which they are attached to and its specific characteristics.

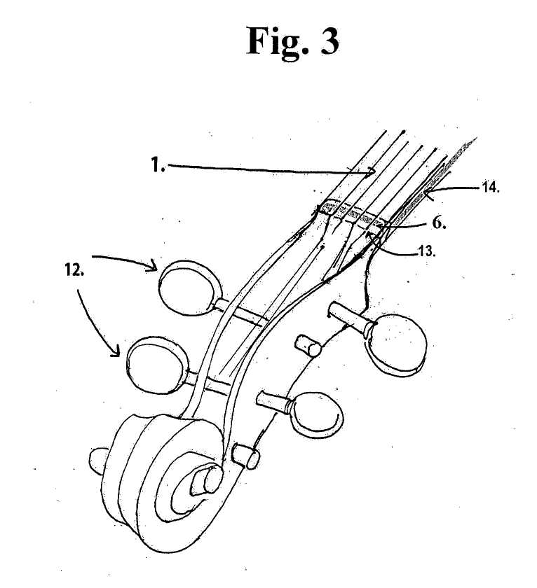

The electrically conductive strings (1) of the instruments are electrically connected to each other, as parts of the overall electronic circuit, one end of the string (FIG. 3) in the pegbox (12), and the other (2, 4 & 5) in the electrically non-conductive tailpiece (4) of the instrument.

### Analytically:

In the pegbox (12) (FIG. 3) electrical connection of the electrically conductive strings (1) to each other and to the rest of the system can be achieved in the following ways:
1) by means of electroconductive adhesive strip-type terminals (6) secured around the nut (13) (FIG. 3).
2) by means of electrically conductive pegs (12), e.g. a double bass with metal, electrically conductive tuning pegs.
3) by means of electrically conductive terminals in the form of clips, spiral (coil), etc., or cable.
4) by means of a metallic nut (13) (FIG. 3) or frets.
5) through contact of the electrically conductive strings each with the other (1).

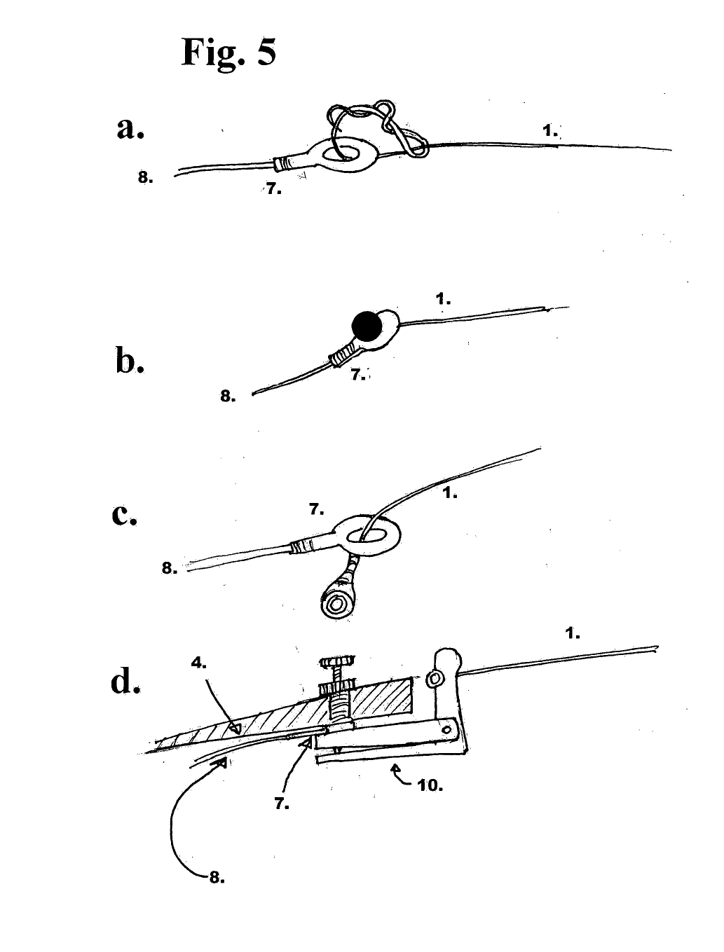

In the electrically non-conductive tailpiece the electrical connection can be achieved (FIGS. 2, 4 & 5) as follows:
1) by use of a loop-shaped or fork-shaped electrically conductive terminals (7) (FIG. 5).
2) by means of fine tuners (10) (FIG. 2, 5δ) where they are applicable.
3) through contact among them.
The ways to connect electrically conductive strings (1) so as to from an electric circuit are the following (FIG. 4):

a) in pairs, by the terminal (7) of the tailpiece (4) to one end of the first string (1) and through the first string to its other end. From there to one end of the second string (1), with a binding in the pegbox (12) (FIG. 3) and through the second string back to the terminal (7) of the other end of the second string and then to the tailpiece (4) (FIGS. 2 & 4). In this case, one terminal (7) of a pair mounted in the tailpiece (4) carries the signal and the other is grounded.

b) as a group, wherein the pairs of the above mentioned case (a) are connected in series or in parallel, with at least one common point of electrical contact, a ground point and an output point of the produced modulated electric signal.

c) each string separately (1) in the tailpiece (4) (one end of the string) and thence, through wiring or a plug (9) to the preamplifier (5). The grounding of all the electrically conductive strings (1) takes place in the pegbox (12) (at the other end of the string) and driven by electroconductive adhesive tape (14) (ideally in the colour of the instrument) along the fingerboard (11) (FIG. 3) or the instrument body to the preamplifier (5), by wiring (8). Alternatively, the grounding of all electrically conductive strings (1) in the pegbox (12) can be done through the instrument by using the metal rod which passes beneath the fingerboard (11), in case it is in-built by construction of the instrument and is directly accessible, through wiring (8) and an output terminal (9) to the preamplifier (5). This third (c) method serves to avoid short-circuit in the electrically conductive strings (1), while playing the instrument, in case there are transverse, electrically conductive metal frets along the fingerboard (11).

The terminals (7) in the tailpiece (4) (FIG. 5) can be connected directly to the electrically conductive tail of the string (1) - beneath or beside the non-conductive tailpiece (4)—either by a loop (string loop) (FIG. 5a) or through an electrically conductive metallic ball (FIG. 5b), or an electrically conductive ring where applicable (ball end) (FIG. 5c), or (FIG. 5d) by a fine tuner (10).

The set of wiring and other parts of the system mounted on the instrument can remain invisible if positioned beneath the tailpiece (4), the chinrest (21) or any other non-echogenic parts of instruments.

The particularly weak electric signals induced by the three-dimensional movement of the electrically conductive strings (1) in said magnetic field are directed through the tailpiece (4) to the preamplifier (5) (FIG. 4) wherein the signals mixing (1), preamplification and final processing are performed.

The preamplifier (5) (FIG. 4), whether built into the instrument or not, is necessarily of low input noise and high signal-to-noise ratio, it bears the possibility for string tension balancing (1) one by one or in groups, it mixes the acoustic modulated electrical signal that is produced by each string or group of strings (1), it has the possibility to interrupt the grounding of the signal line (ground lift) to eliminate ground-related noise and parasitism and it includes a phase shift selector to prevent acoustic resonances and control the harmonics of the signal.

The preamplifier may have the following additional features: the possibility to control the tone quality and the effects of each string (1) one by one or in groups, to add and adjust analog or digital effects (e.g. equalizer, reverb, delay, octave, compressor, limiter, loopers, distortion, etc.), to adjust the final volume of the instrument, to be compact, portable, running on battery or AC, to be able to transmit or receive signal in case (wirelessly), to turn off the signal (mute switch), to have a light (LED) to indicate whether an effect is on or the battery level (provided that a battery is used), and a low-impedance outlet, line or DI (XLR connector) output.

The complete system does not require any interventions or modifications to the instruments, it can be easily attached to or detached from the instrument at any time by the musician him-/herself and it does not affect the natural timbre and sound of the instruments at all, since it is not mounted in echogenic parts of the instrument but at the end of the fingerboard (11), in the pegbox, (12) and beneath the tailpiece (4) and the chinrest (21).

### MAIN ADVANTAGES OF THE SYSTEM

Immediate response to playing, full dynamic range, combined with linear frequency response, unlike (i) magnets using coils, hence exhibiting greater inductance—capacitance, and therefore, filtering and colouring of the sound, and (ii) any piezoelectric solutions which produce nasal timbre because of their resonant frequency response.

Absence of audio feedback unlike any conventional microphones. In fact, the microphone tone quality is achieved, without the inherent problems of a microphone.

Ability to present humbucking (cancelling out of external interference, noise and parasitism).

Adjustable volume, timbre and harmonics of each string or group of strings.

Minimal interventions or no modifications at all to the instruments.

Ability to quickly and easily attaching and detaching of this system by the musician him-/herself.

Discreet or invisible mounting on the instrument, of minimal weight, the system is devoid of any aesthetic annoyance induced by visible wiring or components thereof.

No impact on the natural sound of the instrument (there is no contact at all or minimal contact with the echogenic parts of the instrument).

Ability to modulate the generated signal and add various effects.

Possibility to be installed/uninstalled in a kit format.

1. A detachable electrodynamic sound pickup and amplification system, with a removable mounting plate and self-adhesive cabling, for classical string instruments and other musical instruments having electrically conductive strings, which operates utilizing the modulated electric audio signal produced at the ends of the strings (1) of the instrument when they move three-dimensionally within a suitably shaped magnetic field and it is characterized by a removable mounting plate (3) bearing magnets (2), slidably mounted at the end of the fingerboard (11), self-adhesive electroconductive cabling (14) and self-adhesive terminals (6).

2. A detachable electrodynamic sound pickup and amplification system, with a removable mounting plate and self-adhesive cabling, whose mounting plate (3), as referred to in claim 1, consists of two rigid surfaces that clamp the magnets (2), of which surfaces the first is L-shaped (15a) and the other is flat (15b), a hook/clip (19) adjusted for height in accordance to the instrument, and at least one central attaching screw (16), which penetrates the two surfaces (15a, 15b) and the hook (19) and is responsible for the overall stability of the mounting plate (3), and securing of the magnets (2).

3. A detachable electrodynamic sound pickup and amplification system, with a removable mounting plate and self-adhesive cabling, whose mounting plate (3), as referred to in claim 2, is slidably mounted on the instrument beneath the fingerboard (11) by the longest side of its L-shaped surface (15a), while it is clamped—held therein by adjustment for height of the hook/clip (19), which abuts the top end of the fingerboard (11).

4. A detachable electrodynamic sound pickup and amplification system, with a removable mounting plate and self-adhesive cabling, where the two rigid surfaces (15a, 15b) of the mounting plate (3), as referred to in claim 2, can be coated with non-slip and damping material for better stability, braking action and creaking noises avoidance, while playing the instrument.

5. A detachable electrodynamic sound pickup and amplification system, with a removable mounting plate and self-adhesive cabling, where the strings (1) of the instrument can be connected with the ground line of the system, as well as with subsequent audio processing units, through self-adhesive cabling (14), as is referred to in claim 1, longitudinally of the instrument body.

6. A detachable electrodynamic sound pickup and amplification system, with a removable mounting plate and self-adhesive cabling, where the self-adhesive electroconductive terminals (6), as referred to in claim 1, are responsible for the electrical connection of the strings (1) in the pegbox (12) of the instrument.
